(19) United States
(12) Patent Application Publication
(10) Pub. No.: US 2008/0116238 A1
(43) Pub. Date: May 22, 2008

(54) Kettle holder adapted on a bicycle frame

(76) Inventor: Peng-Yu Tseng, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/601,941

(22) Filed: Nov. 20, 2006

(51) Int. Cl. B62J 11/00

(52) U.S. Cl. 224/414

(57) ABSTRACT

A kettle holder includes an elongated plate adapted to be mounted on a bicycle frame, a holding arm integrally extending from one side of the elongated plate to be vertical to a longitudinal axis of the elongated plate for engagement with one side of a kettle and a helix arm integrally extending from the other side of the elongated plate to be opposite to the holding arm. The helix arm has a bend formed on a free end thereof so that a receiving space is defined among the holding arm, the helix arm and the bend for receiving therein the kettle. The helix arm is able to deform to provide clamping force for engagement with the kettle and when the kettle is removed, the helix arm returns to its original position.

### BACKGROUND OF THE INVENTION

1. Field of the Invention

The present invention relates to a kettle holder, and more particularly to a kettle holder adapted to be mounted on a bicycle holder.

2. Description of the Prior Art

A kettle holder is adapted to be mounted on a bicycle frame such that when the bicker is thirsty, the bicker is able to easily grab the kettle for water. A conventional kettle holder (90) is shown in FIG. 5 and has an elongated plate (91) adapted to be mounted on a bicycle frame (50), a pair of arms (92) respectively extending from opposed sides of the elongated plate (91) and a bend (93) extending from a bottom edge of the elongated plate (91). Due to the provision of the pair of arms (92) and the bend (93), a receiving space (94) is defined in the kettle holder (90).

When the conventional kettle holder (90) is in application, a kettle (not shown) is able to be extend into the receiving space (94) and supported by the bend (93). With the two arms (92), the kettle should be securely clamped in the kettle holder (90). However, if the kettle size is smaller than that of the receiving space (94), the two arms (92) can not engage with the outer periphery of the kettle. Thus the kettle is moving around inside the receiving space (94) when the bicycle is moving along the street. Again, when the kettle size is larger than that of the receiving space (94), the two arms (92) might need to expand to allow the extension of the kettle. After the kettle is received inside the receiving space (94), the clamping force from the two arms (92) might be so large that the bicker may have difficulty removing the kettle out of the receiving space (94).

From the aforementioned description, it is noted that the conventional kettle holder needs to be redesigned to best fit to hold the kettle.

To overcome the shortcomings, the present invention tends to provide an improved kettle holder to mitigate the aforementioned problems.

### SUMMARY OF THE INVENTION

The primary objective of the present invention is to provide an improved kettle holder to securely hold the kettle despite the size of the kettle.

In order to accomplish the foregoing objective, the kettle holder has one arm extending from one side of an elongated plate and a helix arm extending from the other side of the elongated plate and a bend formed on a distal free end of the helix arm.

Preferably, the helix arm extends from a top portion of the elongated plate to the bend in a least distance.

Preferably, the distal free end of the helix arm extends beyond a bottom portion of the elongated plate.

Other objects, advantages and novel features of the invention will become more apparent from the following detailed description when taken in conjunction with the accompanying drawings.

### BRIEF DESCRIPTION OF THE DRAWINGS

FIG. 1 is a perspective view showing that the kettle holder is mounted on a bicycle frame;

FIG. 2 is a top plan view of the kettle holder of the present invention;

FIG. 3 is a schematic view showing that a kettle is received in the receiving space of the kettle holder of the present invention;

FIG. 4 is a schematic top plan view showing change of the kettle holder of the present invention after the kettle is received in the receiving space; and

FIG. 5 is a perspective view of a conventional kettle holder adapted to be mounted on a bicycle frame.

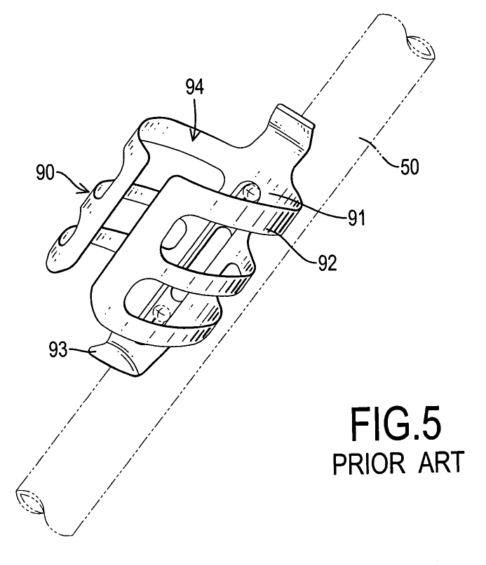

### DETAILED DESCRIPTION OF THE PREFERRED EMBODIMENT

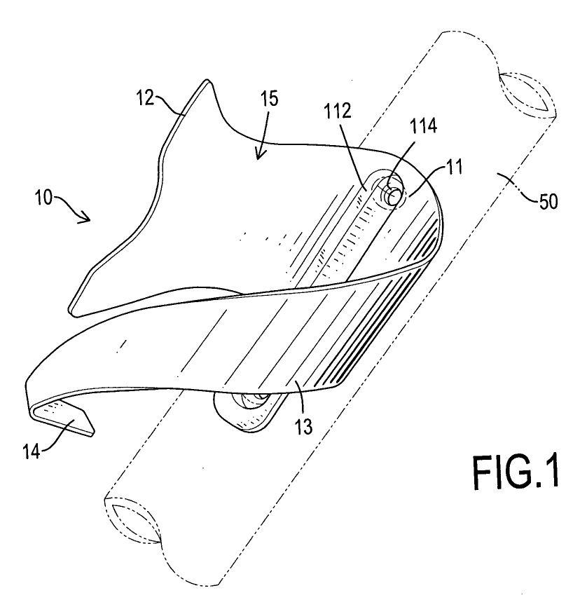

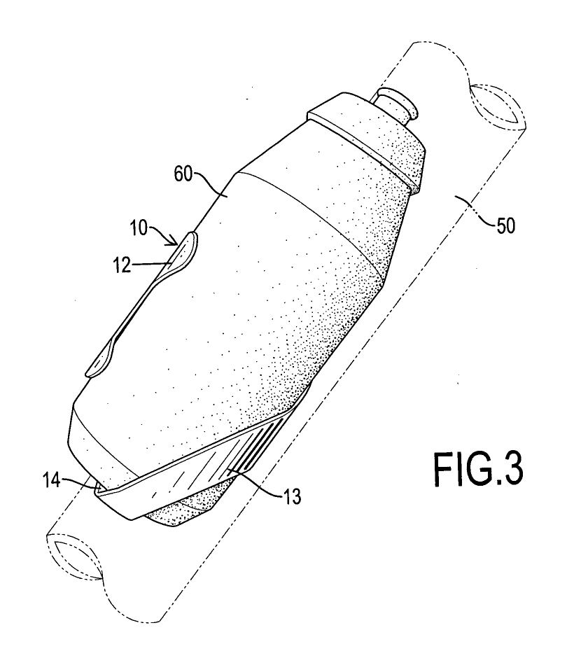

With reference to FIGS. 1, 2 and 3, it is noted that the kettle holder (10) in accordance with the present invention includes an elongated plate (11) having an elongated recess (112) defined along a longitudinal axis of the elongated plate (11) and two through holes (114) defined in two opposed ends of the elongated recess (112). With the provision of the two through holes (114), the operator is able to use fasteners such as screws, rivets, bolts or the like to secure the elongated plate (11) onto a bicycle frame (50). Further, due to the provision of the elongated recess (112), after the fasteners are extended and received in the two through holes (114), the fasteners do not hinder extension of a kettle extending into the kettle holder of the present invention.

A holding arm (12) is integrally extended from one side of the elongated plate (11) to be vertical to the longitudinal axis of the elongated plate (11) and a helix arm (13) is integrally formed on the other side of the elongated plate (11) to be inclined relative to the longitudinal axis of the elongated plate (11). The helix arm (13) has a bend (14) formed on a distal free end thereof so that a receiving space (15) is defined by the holding arm (12), the helix arm (13) and the bend (15).

When a kettle (60) is extended into the receiving space (15), one side of the outer periphery of the kettle (60) is held by the holding arm (12) and the other side of the outer periphery of the kettle (60) is held by the helix arm (13). A bottom face of the kettle (60) is held and supported by the bend (14).

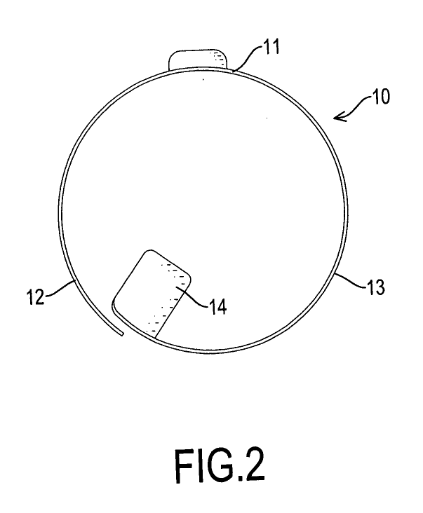

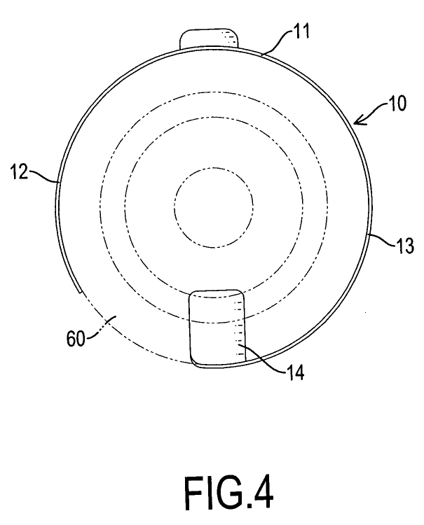

In comparison between the structure as shown in FIG. 2 and the structure as shown in FIG. 4, it is noted that after the kettle (60) is received in the receiving space (15), due to the weight of the kettle, the helix arm (13) extends in a direction substantially parallel to the longitudinal axis of the elongated plate (11). Furthermore, before, the kettle (60) is received in the receiving space (15), the position of the bend (14) extends beyond a position opposite to the elongated plate (11). After the kettle (60) is received in the receiving space (15), due to the extension of the helix arm (13), the position of the bend is opposite to that of the elongated plate (11). Preferably, the helix arm (13) extends from a top portion of the elongated plate (11) to the bend (14) in a least distance so that the clamping force to the kettle (60) is sufficient. That is, the helix arm (13) extends downward from a top portion of the elongated plate (11) in substantially 45 degrees for a least distance.

In conclusion, it is noted that with the helix arm (13), the kettle holder (10) of the present invention provides flexibility to clamp the kettle (60) of different sizes. When the kettle (60) is removed from the receiving space (15), the clamping force from the helix arm (13) is instantly released to allow the bicker to easily remove the kettle (60) from the receiving space (15) and then the helix arm (13) returns to its original position. Therefore, it is to be noted that the kettle holder of the present invention is able to fit to kettles of different sizes. And when the kettle is received in the receiving space (15) of the kettle holder (10), the extension of the helix arm (13) provides clamping force to clamp the kettle. When the kettle is to be removed from the receiving space (15), the clamping force to the kettle is released to allow the bicker to easily remove the kettle from the receiving space (15).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A kettle holder comprising:
an elongated plate adapted to be mounted on a bicycle frame;
a holding arm integrally extending from one side of the elongated plate to be vertical to a longitudinal axis of the elongated plate for engagement with one side of a kettle; and
a helix arm integrally extending from the other side of the elongated plate to be opposite to the holding arm, the helix arm having a bend formed on a free end thereof so that a receiving space is defined among the holding arm, the helix arm and the bend for receiving therein the kettle, wherein the helix arm is constructed in such a way that when the kettle is received in the receiving space, the helix arm is able to deform in a direction substantially parallel to the longitudinal axis of the elongated plate to provide clamping force for engagement with the other side of the kettle and when the kettle is removed, the helix arm returns to its original position.

2. The kettle holder as claimed in claim 1, wherein the helix arm is extended from a top portion of the elongated plate to the bend in for a least distance.

3. The kettle holder as claimed in claim 1, wherein the helix arm is constructed in such a manner that before the kettle is received in the receiving space, a position of the bend is beyond a position oppositely relative to a position of the elongated plate and after the kettle is received in the receiving space, the position of the bend is opposite to the position of the elongated plate.

4. The kettle holder as claimed in claim 2, wherein the helix arm is constructed in such a manner that before the kettle is received in the receiving space, a position of the bend is beyond a position oppositely relative to a position of the elongated plate and after the kettle is received in the receiving space, the position of the bend is opposite to the position of the elongated plate.

5. The kettle holder as claimed in claim 1, wherein the elongated plate has an elongated recess and two through holes respectively defined in two opposed ends of the elongated recess for allowing two fasteners to extend through the two through holes for engagement with the bicycle frame.

6. The kettle holder as claimed in claim 2, wherein the elongated plate has an elongated recess and two through holes respectively defined in two opposed ends of the elongated recess for allowing two fasteners to extend through the two through holes for engagement with the bicycle frame.

7. The kettle holder as claimed in claim 3, wherein the elongated plate has an elongated recess and two through holes respectively defined in two opposed ends of the elongated recess for allowing two fasteners to extend through the two through holes for engagement with the bicycle frame.

8. The kettle holder as claimed in claim 4, wherein the elongated plate has an elongated recess and two through holes respectively defined in two opposed ends of the elongated recess for allowing two fasteners to extend through the two through holes for engagement with the bicycle frame.
